(19) United States
(12) Patent Application Publication
(10) Pub. No.: US 2020/0234248 A1
(43) Pub. Date: Jul. 23, 2020

(54) TECHNOLOGY APPLYING A DEPENDENCY GRAPH TO GENERATE AN UPDATED TEACHING PLAN BASED ON UNEXPECTED EVENTS

(71) Applicant: International Business Machines Corporation, Armonk, NY (US)

(72) Inventors: Geetha KARNA, Bengaluru (IN); Danish CONTRACTOR, Gurgaon (IN); Sreekanth L. KAKARAPARTHY, Bangalore (IN); Kuntal DEY, Vasant Kunj (IN)

(21) Appl. No.: 16/250,922

(22) Filed: Jan. 17, 2019

(51) Int. Cl. G06Q 10/10; G06Q 10/04; G06Q 50/20; G06F 16/901; G06F 16/951

(52) U.S. Cl. CPC G06Q 10/1093; G06Q 10/04; G06F 16/951; G06F 16/9024; G06Q 50/205

(57) ABSTRACT

Methods and systems may provide for technology to calculate an amount of time that it will take to teach a topic based on input data that defines a schedule, compute an updated amount of time that it will take to teach the topic based on information related to an unexpected event and dependent concepts related to the topic, automatically calculate a possible time period in which concepts can be taught before an occurrence of the unexpected event; determine whether concepts are coverable in the calculated time period, and automatically reorganize the schedule based on the updated amount of time that it will take to teach the topic and the calculated time period before the occurrence of the unexpected event.

### BACKGROUND

Embodiments generally relate to technology that automatically generates a reorganized plan of teaching a curriculum. More particularly, embodiments relate to curriculum planning based on concept dependency graphs.

Unplanned events may cause planned classes and teaching sessions to be canceled, delayed, or postponed. Accordingly, the topics intended to be covered in a particular syllabus may not be completed and undue stress and burden may be placed on students and educators.

### BRIEF SUMMARY

Embodiments include a performance-enhanced computing device comprising network interface circuitry to receive data related to a schedule for teaching a topic and information related to an unexpected event, a processor coupled to the network interface circuitry, and a computer readable storage medium coupled to the processor, the computer readable storage medium having program instructions embodied therewith. The program instructions are executable by the processor to cause the computing device to calculate an amount of time that it will take to teach the topic based on the received data related to the schedule, determine whether to update the amount of time that it will take to teach the topic based on information related to an unexpected event and dependent concepts related to the topic, if it is determined that the amount of time is to be updated, compute an updated amount of time that it will take to teach the topic based on the information related to the unexpected event and dependent concepts related to the topic, automatically calculate a possible time period in which concepts can be taught before an occurrence of the unexpected event, determine whether concepts are coverable in the calculated possible time period before the occurrence of the unexpected event, and automatically reorganize the schedule across multiple lectures based on the updated amount of time it will take to teach the topic and the possible time period before the occurrence of the unexpected event.

Embodiments also include a method comprising calculating an amount of time that it will take to teach a topic based on input data that defines a schedule, determining whether to update the amount of time that it will take to teach the topic based on information related to an unexpected event and dependent concepts related to the topic, if it is determined that the amount of time is to be updated, computing an updated amount of time that it will take to teach the topic based on information related to an unexpected event and dependent concepts related to the topic, automatically calculating a possible time period in which concepts can be taught before an occurrence of the unexpected event, determining whether concepts are coverable in the calculated possible time period before the occurrence of the unexpected event, and automatically reorganizing the schedule based on the updated amount of time that it will take to teach the topic and the possible time period before the occurrence of the unexpected event.

Embodiments also include a computer program product to reorganize a schedule, the computer program product comprising a computer readable storage medium having program instructions embodied therewith, the program instructions executable by a computing device to cause the computing device to calculate an amount of time that it will take to teach a topic based on input data that defines the schedule, determine whether to update the amount of time that it will take to teach the topic based on information related to the unexpected event and dependent concepts related to the topic, if it is determined that the amount of time is to be updated, compute an updated amount of time that it will take to teach the topic based on information related to an unexpected event and dependent concepts related to the topic, automatically calculate a possible time period in which concepts can be taught before an occurrence of the unexpected event, determine whether concepts are coverable in the calculated possible time period before the occurrence of the unexpected event, and automatically reorganize the schedule across multiple lectures based on the updated amount of time that it will take to teach the topic and the possible time period before the occurrence of the unexpected event.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is an illustration of an example of a system according to an embodiment;

FIG. 2 is a flowchart of an example of a method of automatically generating a reorganized schedule according to an embodiment;

FIG. 3 is a flowchart of an example of a method of automatically reorganizing a schedule by employing a concept dependency graph according to an embodiment;

FIG. 4 is a flowchart of an example of a method of automatically reorganizing a schedule when additional teaching time cannot be added to the schedule, according to an embodiment;

FIG. 5 is a block diagram of an example of a performance-enhanced computing device according to an embodiment; and

FIG. 6 is an illustration of an example of a semiconductor apparatus according to an embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network comprises copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

When planning a schedule for teaching a particular topic, class or curriculum, a school or education system typically plans the schedule well in advance of the start of classes and takes into considerations known occurrences, including holidays and the like. Schedule disruption may occur due to unexpected occurrences like social disruptions, conditions of uncertainty, unplanned outages like hurricanes/cyclones and other natural disasters, which impact the class schedules of the affected region, thereby causing schools to shut down.

There may be school district closings due to inclement weather, utility service disruption or other emergency issues that might compromise the safety of students or staff.

Planned classes may get cancelled and it may become difficult to cover all the concepts and topics in the syllabi on time, which may result in not completing the syllabi or there may be overburdening/overstretching of students and educators to cover the missed syllabi subjects due to unexpected disruptions. Additionally, more time may be demanded from educators in order to complete the curriculum.

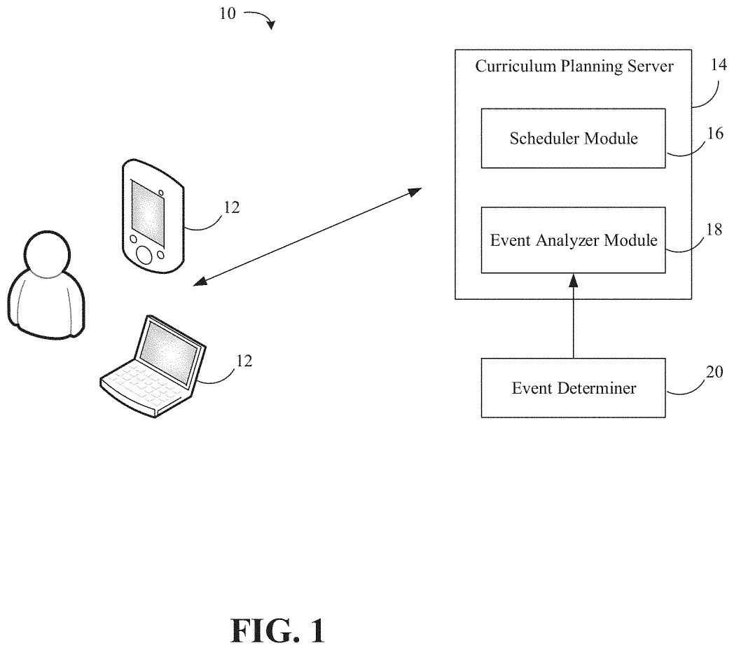

Turning now to FIG. 1, a computing architecture 10 (e.g., communications system) is shown in which a client device 12 (e.g., laptop, mobile device, personal computer) communicates with a curriculum planning server 14 that reorganizes lecture plans. The illustrated client device 12 receives curriculum teaching schedules and plans from the curriculum planning server 14. In an embodiment, the curriculum planning server 14 includes a scheduler module 16 and an event analyzer module 18. The curriculum planning server 14 could be a single server device or multiple server devices. An event determiner 20 provides the event analyzer module 18 with information related to an event that was not considered when a curriculum or syllabus was initially planned.

According to an exemplary embodiment, the curriculum planning server 14, including the scheduler module 16 and an event analyzer module 18, reorganizes class lecture sequence or schedule plans and the like (in educational institutes, and across multiple classes/lectures/lecture units), when previously unplanned events become known or occur ahead of the start of a class or lecture. Also, according to an embodiment, when a new concept (unknown to the students) will be taught in an upcoming class, and it is to be taught over more than one class/lecture, as a non-continuation of any earlier concept, the curriculum planning server 14 performs calculations to automatically reorganize schedules so that the class can cover concepts that need not continue across the break-of-classes caused by now-known unplanned events.

To automatically reorganize lecture sequence or schedule plans, the curriculum planning server 14 may employ a concept dependency graph, which establishes a relationship across concepts dependent on the lecture sequence (i.e., dependent concepts) with concepts that are prerequisites to the lecture sequence (i.e., prerequisite concepts), and for each concept, the standard number of classes (lectures) or standard hours needed to cover the concept may be assigned thereto. According to an embodiment, the standard number of hours and/or lectures are determined by state or nationally recognized education entities that determine the standard number of hours or lectures for teaching academic subjects, topics, or concepts of a topic—such as, for example, the National Center for Education Statistics and the like.

The event analyzer module 18 of curriculum planning server 14 receives information from social media, weather department channels, and other public sources, to identify potential big events and natural phenomenon that may potentially disrupt existing lecture plans, and then compute the number of classes (and lecture hours) that this event/phenomenon will upset/disrupt. Operations of the scheduler module 16 and event analyzer module 18 will be discussed in further detail below.

The scheduler module 16 of the curriculum planning server 14 calculates the number of classes, lectures, or lectures hours that are able to be taught prior to the occurrence of the event/phenomenon. The scheduler module also calculates the standard number of hours and/or lectures after the occurrence of the event/phenomenon it will take to completely teach a lecture curriculum.

According to an exemplary embodiment, among its many operations, the curriculum planning server 14 employs the scheduler module 16 and/or the event analyzer 18 to compute the dependent concepts that are to be covered within an updated number L of lecture hours/classes, given all the classes taught to date, to reorganize the class material such that a dependent concept is fully covered/taught in the updated L lecture hours (using the original or updated value of L) before the event/phenomenon occurs, and to generate recommendations to be transmitted educators the standard number of hours/lectures necessary to cover the topic before and/or after the event/phenomenon.

For example, a topic that takes 3-hours to cover, may have been planned to be taught in a particular week. Unexpectedly, early in the week, a storm may be predicted for Thursday of the week. Because of the unexpected storm, it will be possible to spend only 2 hours of lecture on this subject. Accordingly, the curriculum planning server=calculates and automatically finds a different subject from the curriculum that takes 2 hours or slightly less to teach, where all the other concepts the new subject depends upon has been taught already, and thus this new subject can be taught without concern that prerequisite concepts need to be covered first.

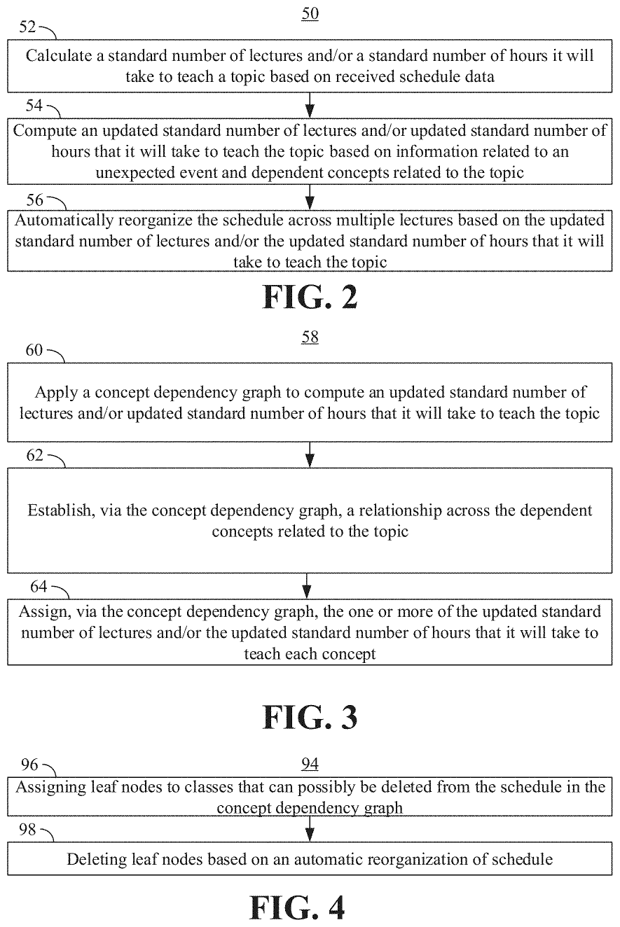

FIG. 2 shows a method 50 of automatically reorganizing an existing teaching schedule. The method 50 may generally be implemented in fixed-functionality hardware, configurable logic, logic instructions, etc., or any combination thereof. For example, the logic instructions might include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 52 calculates a standard number of lectures and/or standard number of hours it will take to teach a topic based on known schedule date.

Illustrated block 54 provides for computing an updated standard number of lectures and/or updated standard number of hours to teach the topic, based on information related to an unexpected event and dependent concepts related to the topic. That is, in an exemplary embodiment, a curriculum planning server 14 analyzes information related to the unexpected event as well as information related to dependent concepts related to the topic to determine the above-mentioned updated lectures and/or hours. According to an embodiment, a topic may be, for example, the title of a class that is taught over the course of a semester (e.g., Calculus). A concept related to the ‘Calculus’ topic may be ‘differential equations’.

Illustrated block 56 automatically reorganizes a previously established schedule across multiple lectures based on the updated standard number of lectures and/or the updated standard number of hours that it will take to teach the topic.

According to an exemplary embodiment, in a scenario that any University/School/Educational Institute does not have any provision to have extra lectures/classes in lieu of the classes that are loss due to the event/phenomenon, a method to suggest concepts (e.g., in the form of leaf concepts in a concept dependency graph) that may be excluded from the syllabus is provided, thus the lecture plan schedule is updated to make sure that all the other concepts related to a topic are covered. If multiple dependencies are discovered, then the hyper-nodes (hyper-vertices) of a concept dependency graph are be selected for removal and the most important concepts are retained.

For example, a scenario may occur where the amount of time to teach a particular subject is 1 hour less than originally planned due to an occurrence of an unexpected event, and there is no way that the 1 hour can be rescheduled. In that case, a topic that requires more than 1 hour of teaching in the original plan (for example, planned for 3 hours) is removed, and the segments with the lowest concept importance value are recommended for removal to the teacher, such that, the total removal is for 1 hour of material, and no removal is recommended “from the middle” (that is, the removed concept is not a prerequisite for another concept that was not removed). Such calculation and technological solution are provided via the curriculum planning server and its constituent scheduler module and event analyzer module.

According to another embodiment, the event analyzer module 18 creates a concept dependency hypergraph, before a course for a particular topic begins. The concept dependency graph is created using the course material (content), syllabus (keywords), teachers' (subject matter experts') indications of importance of each concept, relationship (dependency, prerequisites etc.) of the concepts, difficulty level of each concept, and time to be spent for each concept. The importance and difficulty of each concept is reflected by, for example, a score which is equivalent to the knowledge value contained in that concept.

The concept dependency hypergraph includes: each concept as a vertex, a set of related concepts (vertices) that need to be covered in one class or one sequence of classes, as a meta-vertex (e.g., a lecture unit), a set of inter-relationships among the vertices (within the meta-vertex) that are a set of concepts that need to be taught together as one unit (spread over a single class or a set of adjacent classes), and a set of inter-relationships among the meta-vertices, which indicate which set of classes need to be covered before other sets of classes (prerequisites/dependencies).

FIG. 3 shows a method 58 of computing an updated standard number of lectures and/or hours to teach a topic. In an embodiment, the method 58 is readily substituted for block 54 (FIG. 2), already discussed. Thus, the method 58 may generally be implemented in fixed-functionality hardware, configurable logic, logic instructions, etc., or any combination thereof. For example, the logic instructions might include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, CPU, microcontroller, etc.).

Illustrated processing block 60 applies a concept dependency graph to compute an updated standard number of lectures and/or updated standard hours estimated to teach the topic. In the illustrated example, block 62 establishes, via the concept dependency graph, a relationship across the dependent concepts related to the topic. Illustrated processing block 64 assigns, via the concept dependency graph, the updated standard number of lectures and/or the standard hours that it will take to teach each concept of the topic.

As indicated above, information to identify big events and phenomenon are identified using social media, weather department channels, and other public sources. The result of the above may be that the number of days, in a given geographical area, that public life is likely to be impacted may be characterized as slightly disrupted, majorly disrupted, completely hampered etc.

According to an embodiment, by using data/information related to the (a) type, (b) duration and (c) degree of hampering of a particular event/phenomenon, a simple but practical novel method to identify the quantum of loss that the education system (classes) is likely to suffer, is provided. For example, by estimating the starting time and duration of the event/phenomenon, and overlapping that with the class timetable/calendar, the number of classes that are likely to be impacted, may be determined. A probability generation function is executed, that takes as input the type and degree of the event/phenomenon, and, using historical evidence as the learning platform, generates the likelihood of a student attending the lecture. In turn, the resultant data is multiplied by the number of students in the class, to estimate a total attendance. If the total attendance is less than a policy-permitted threshold, then the lecture may be considered as abandoned. Further, the probability generation function may also compute the probability of regulatory agencies organically cancelling the class given the upcoming event/phenomenon (and also may consider announcements of cancellation on the public media), and if known to be cancelled, or if the probability of cancellation is above a threshold, then the lecture may also be considered as abandoned.

According to an embodiment, an algorithm is employed to calculate the number of classes possible to be taught before the occurrence of the unplanned event or natural phenomenon. If in one exemplary case one or more upcoming classes are labeled as abandoned at the earlier stage, a method is executed to count the standard number of classes/lecture hours L that are spent on concepts of a topic before the event/phenomenon starts. This is achieved by finding out the current date/time, the predicted/known date time of the first abandonment of the classes due to the event/phenomenon, and overlapping that with the timetable/class schedule to count the number of overlapping classes (and duration of these classes). The output of this calculation is L, the number of lecture-hours/classes that are possible to be taught between now and the class disruption.

According to another embodiment, a calculation, using an algorithm, to identify the time (any update of lecture hours L) for which the set of next concepts related to a topic need to be reorganized in order to be taught subsequent to a major event or natural phenomenon, may be performed. According to a first scenario, if the current topic that is being covered, takes exactly L lecture-hours more, no change is made to the pre-disruption class plans. According to a second scenario, if the current topic that is being covered, takes more than L lecture-hours from this time-point, leaf nodes are identified within the meta-vertex of the current lecture. If removing leaf nodes with the lowest concept importance values brings down the total time remaining to L lecture hours, while the total concept score of the remaining hypergraph vertex remains higher than a given threshold, then the leaf nodes are removed. Otherwise, no action is taken (and the break due to the unplanned event/phenomenon will happen in the middle of the concept teaching). In that case, the current topic is labeled as cover-able. The above-referenced total concept score is computed as the sum of the concept importance scores of all the nodes being considered.

According to a third example scenario, if the current topic that is being covered, takes more hours M, which is less than L lecture hours estimated to complete a topic, then L is updated to L=L−M and this value of L is used for finding concepts that can be taught in the updated L number of hours. According to a fourth example scenario, if the previous topic had ended in the current class, then the next topic to cover will involve total number of L hours, so L is used as the input to the next stage.

According to an embodiment, as described above, a method may be executed to compute the dependent concepts that can be covered within L lecture hours/classes, given all the courses taught to date, and automatically reorganize the class material such that a dependent concept (with zero or more prerequisites) is fully covered in the L lecture hours (using the original or updated value of L, as determined by the method of identifying cover-able concepts) before the event/phenomenon occurs, and recommend an updated schedule to the educators. A set of concepts are chosen, that are not yet covered, and either have no prerequisites, or have prerequisites that have been fully covered in the earlier lecture material, and that take L lecture hours/classes to complete (one or more concepts are chosen, such that the total is L lecture hours/classes).

If no such concept exists, then all the lecture units with the smallest number of lecture hours/classes are chosen (in this case, each of these values is higher than L), and then, the one with the lowest total difficulty level of the concept and highest importance level (obtained as a function of the difficulty levels and importance levels of the constituent concepts) is chosen, up to a permissible threshold. Here too, leaf nodes are identified within the meta-vertex of the current lecture. If removing identified leaf nodes values brings down the total time remaining to complete L lecture hours, while the total concept score of the remaining hypergraph vertex remains higher than a given threshold, then such is carried out. Otherwise, the whole concept may be taught, spanning across the intermediate class disruption.

The method 50 therefore enhances performance by enabling the computing of an updated standard number of lectures and/or updated standard number of hours that it will take to teach a topic/concept and the automatic reorganization of a schedule across multiple lectures based on the updated standard number of lectures and/or updated hours that it will take to teach a topic/concept. Existing systems may be efficiently updated by employing the operations and technology of the instant disclosure.

Further, exemplary embodiments of the instant disclosure provide a technical solution to a technical problem by improving the performance of any existing automated curriculum planners, by employing algorithms, as detailed herein above and below, that require specific inputs and better understanding of the time at hand before an unplanned break or occurrence, the concepts (and their difficulties) that can be covered within that time, and updating the concepts to be taught so that no concept is left in the middle of being taught across the long break of classes.

FIG. 4 shows a method 94 of applying a concept dependency graph in the instance that a school or educational institution cannot add additional classes and needs to analyze the possibility of removing existing classes from the schedule. The method 94 may generally be implemented in fixed-functionality hardware, configurable logic, logic instructions, etc., or any combination thereof. For example, the logic instructions might include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, CPU, microcontroller, etc.).

Illustrated processing block 96 provides assigning leaf nodes to classes that can possibly be deleted from the schedule in the concept dependency graph. In an embodiment, the class has no dependency towards any further concept (e.g., it not a prerequisite of any further concept to be taught). In an embodiment, block 98 includes deleting leaf nodes in the concept dependency graph based on an automatic reorganization of schedule.

A use case example of the implementation of one or more of the above aspects of the instant disclosure is shown below, based on a topic/school curriculum related to Grade 4 Mathematics. The main module/topic and perquisites are set forth below.

Main Module: Find Factors of numbers to 100

Prereq1: Identify Prime numbers 1-100

Prereq2: Identify Composite numbers 1-100

Prereq3: Identify Greatest Common Factor

Prereq4: Identify Least Common Factor

Prereq5: Rules of divisibility

In this example scenario, teacher A must complete Prereq 1 and Prereq2 on January 28, followed by Prereq 3, Prereq4, and Prereq 5 on January 29, and the Main Module is to be covered on January 30. Due to predicted heavy snow fall, an emergency school shutdown gets declared for January 28 and 29—no official declaration was available beforehand.

Teacher A struggles to complete the main module with prerequisites all on January 30 which implies that students also struggle to understand the main module without proper prerequisites foundations. Accordingly, as indicated below, aspects of the instant solution may be applied in this instance.

The event analyzer 18 of curriculum planning server 14 receives input from the event determiner 20 that indicates the predicted natural disasters, social events and other disruptions, using social media and public sites such as weather channel, metallurgical sites etc., on the evening of January 21. From this, the scheduler module 16 calculates that 2 days of classes will be wasted (28^{th} and 29^{th} January), and further automatically consider that there is a 1-week holiday coming up from 2^{nd} February. Additionally, it is automatically noted that the January 21 class will be normal, and only 1 class will take place before the 2-day weather break (on January 22).

The curriculum planning server 14 automatically determines that the degree of difficulty of the concept (“Find Factors”) is relatively high, so the server determines that it is important to take the three classes in a continuous manner.

At this stage, the curriculum planning server 14 generates a set of alternative short 1-day modules, which have appropriately satisfied the prerequisites condition (either these do not have any prerequisite, or all the prerequisites have been taken by the students). The curriculum planning server calculations may suggest to teachers to cover these educational concepts in the class of January 22 (assuming that she has finished teaching her previous topic on 21^{th} January).

Further, the calculations of the curriculum planning server 14 result in automatically generated recommendations that the “Find Factors” concept be taught over classes organized on February 12 to 14, in order to ensure continuity of class material.

If, in this instance, a University/School/Educational Institute does not have any provision to have extra lectures/classes/extra workdays in lieu of the lost classes, then a few concepts may be explored. In an embodiment, by using a concept dependency graph, reorganizing an existing schedule includes the curriculum planning server 14 (a) analyzing the position of the relevant concept, which needs to be a leaf node in the concept graph, with no dependency towards any further concept (e.g., not a prerequisite of any further concept to be taught) and (b) the importance assigned, if any, to these concepts by the subject matter expert (such as teacher) needs to be low—these concepts are eliminated from the overall concept graph, to make sure that the course is minimally hampered.

Below, another use case example of the implementation of one or more of the above aspects of the instant disclosure is shown. That is, in a scenario when Pythagorean theorem prerequisites must be taught by a teacher for 3 days and, due to some disruptions, 2 days have been declared as holidays, all planned content for those 2 days will be skipped. This will impact the upcoming planned class schedule to complete a main module related to Pythagorean Theorem. In this case, the teacher will be in a hurry to complete the schedule and may teach in a very concise and incomplete manner.

This may result in the concepts not being clearly taught to students and there may be a problem that a student may not properly understand and may fail to absorb the Pythagorean theorem. According to an exemplary embodiment, a curriculum planning server 14 or corresponding system analyzes inputs from various sites/social media, channel predictions, etc., and automatically reorganize/rearrange/accommodate the impacts of schedules and minimizes the risk of school planned curriculum schedules.

Finally, in yet another example use case, to complete the syllabus on time a school may conduct extra classes to compensate for missed classes. Students and teachers may get stressed by making extra classes to overly stretch the teaching schedule, to complete the missing schedule. An innovative solution according to an exemplary embodiment is to rearrange class schedules by considering the inputs from various sites/social media, channels predictions, etc. Such technology reduces the stress of educators and minimize any overdemand of students' time.

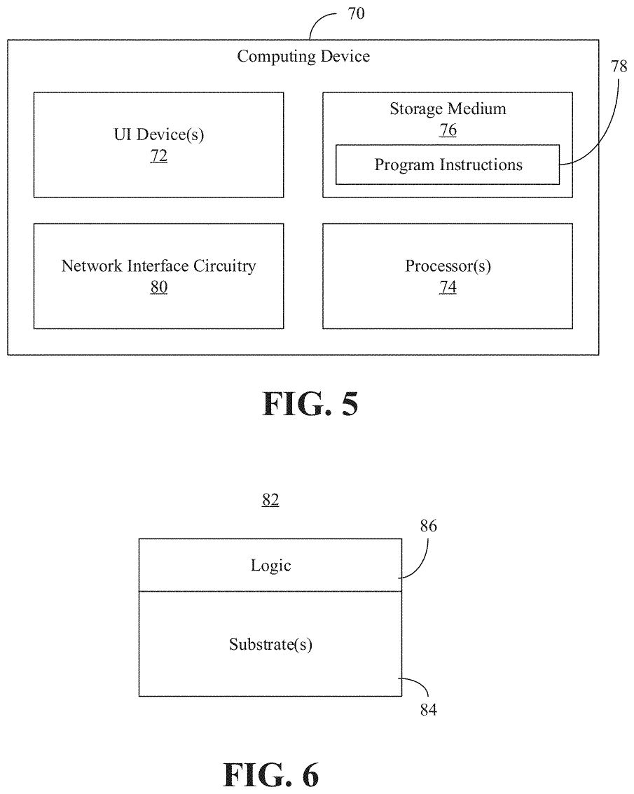

FIG. 5 shows a computing device 70 that may be used to perform any of the methods of FIGS. 2-4. The illustrated computing device 70, which may be centralized (e.g., client device, server) or distributed (e.g., data center, cloud computing infrastructure), includes one or more user interface (UI) devices 72 (e.g., keyboard, mouse, touch pad, touch screen, monitor, microphone, speaker). One or more processors 74 are coupled to the UI device(s) 72, network interface circuitry 80 that receives data access statistics (e.g., user identifiers/IDs, device IDs, location IDs, etc.), and a storage medium 76 (e.g., non-volatile memory, volatile memory, etc., or any combination thereof). In the illustrated example, the storage medium 76 includes program instructions 78 embodied therewith. The program instructions 78 are executable by the processors 74 to cause the computing device 70 to perform one or more aspects of the method 50 (FIG. 2), the method 58 (FIG. 3) and/or the method 94 (FIG. 4), already discussed.

Thus, execution of the program instructions 78 causes the computing device 70 to calculate a standard number of lectures and/or standard number of hours it will take to teach a topic based on known schedule date, compute an updated standard number of lectures and/or updated standard number of hours to teach the topic, based on information related to an unexpected event and dependent concepts related to the topic, and automatically reorganize a previously established schedule across multiple lectures based on the updated standard number of lectures and/or the updated standard number of hours that it will take to teach the topic. In one example, the program instructions 78 are executable to cause the computing device 70 to analyze information related to the unexpected event as well as information related to dependent concepts related to the topic to determine the above-mentioned updated lectures and/or hours.

Turning now to FIG. 6, a semiconductor package 82 (e.g., chip, die) that includes one or more substrates 84 (e.g., silicon, sapphire, gallium arsenide) and logic 86 (e.g., transistor array and other integrated circuit/IC components) coupled to the substrate(s) 84. The logic 86, which may be implemented at least partly in configurable logic and/or fixed-functionality hardware logic, may generally implement one or more aspects of the method 50 (FIG. 2), the method 58 (FIG. 3) and/or the method 94 (FIG. 4), already discussed.

Thus, the illustrated logic 86 calculates a standard number of lectures and/or standard number of hours it will take to teach a topic based on known schedule date, computes an updated standard number of lectures and/or updated standard number of hours to teach the topic, based on information related to an unexpected event and dependent concepts related to the topic, and automatically reorganizes a previously established schedule across multiple lectures based on the updated standard number of lectures and/or the updated standard number of hours that it will take to teach the topic.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computing device comprising:
network interface circuitry to receive data related to a schedule for teaching a topic and information related to an unexpected event;
a processor coupled to the network interface circuitry; and
a computer readable storage medium coupled to the processor, the computer readable storage medium having program instructions embodied therewith, the program instructions executable by the processor to cause the computing device to:
calculate an amount of time that it will take to teach the topic based on the received data related to the schedule;
determine whether to update the amount of time that it will take to teach the topic based on information related to the unexpected event and dependent concepts related to the topic;
if it is determined that the amount of time is to be updated, compute an updated amount of time that it will take to teach the topic based on the information related to the unexpected event and the dependent concepts related to the topic;
automatically calculate a possible time period in which concepts can be taught before an occurrence of the unexpected event;
determine whether concepts are coverable in the calculated possible time period before the occurrence of the unexpected event; and
automatically reorganize the schedule across multiple lectures based on the updated amount of time it will take to teach the topic and the possible time period before the occurrence of the unexpected event.

2. The computing device of claim 1, wherein the program instructions are executable to cause the computing device to apply a concept dependency graph to compute the updated amount of time it will take to teach the topic.

3. The computing device of claim 2, wherein the concept dependency graph is to establish a relationship across the dependent concepts related to the topic, and wherein, for each concept, the concept dependency graph indicates the updated amount of time it will take to teach each concept.

4. The computing device of claim 1, wherein the information related to the unexpected event is received from sources selected from the group consisting of social media and weather channels.

5. The computing device of claim 1, wherein the program instructions are further executable to cause the computing device to generate concepts related to the topic that are excludable from the schedule.

6. The computing device of claim 1, wherein the amount of time that it will take to teach the topic is selected from the group consisting of a standard number of lectures and a standard number of hours.

7. A method comprising:
calculating an amount of time that it will take to teach a topic based on input data that defines a schedule;
determining whether to update the amount of time that it will take to teach the topic based on information related to an unexpected event and dependent concepts related to the topic;
if it is determined that the amount of time is to be updated, computing an updated amount of time that it will take to teach the topic based on the information related to the unexpected event and the dependent concepts related to the topic;
automatically calculating a possible time period in which concepts can be taught before an occurrence of the unexpected event;
determining whether concepts are coverable in the calculated possible time period before the occurrence of the unexpected event; and
automatically reorganizing the schedule based on the updated amount of time that it will take to teach the topic and the possible time period before the occurrence of the unexpected event.

8. The method of claim 7, wherein the computing the updated amount of time includes applying a concept dependency graph.

9. The method of claim 8, further comprising establishing, via the concept dependency graph, a relationship across the dependent concepts related to the topic, and assigning, via the concept dependency graph, the amount of time it will take to teach each concept.

10. The method of claim 7, further comprising receiving the information related to the unexpected event from sources selected from the group consisting of social media and weather channels.

11. A computer program product to reorganize a schedule, the computer program product comprising a computer readable storage medium having program instructions embodied therewith, the program instructions executable by a computing device to cause the computing device to:
calculate an amount of time that it will take to teach a topic based on input data that defines the schedule;
determine whether to update the amount of time that it will take to teach the topic based on information related to the unexpected event and dependent concepts related to the topic;
if it is determined that the amount of time is to be updated, compute an updated amount of time that it will take to teach the topic based on information related to an unexpected event and dependent concepts related to the topic;
automatically calculate a possible time period in which concepts can be taught before an occurrence of the unexpected event;
determine whether concepts are coverable in the calculated possible time period before the occurrence of the unexpected event; and
automatically reorganize the schedule across multiple lectures based on the updated amount of time that it will take to teach the topic and the possible time period before the occurrence of the unexpected event.

12. The computer program product of claim 11, wherein the program instructions are executable to cause the computing device to apply a concept dependency graph to compute the updated amount of time it will take to teach the topic.

13. The computer program product of claim 12, wherein the concept dependency graph establishes a relationship across the dependent concepts related to the topic, and wherein, for each concept, the concept dependency graph indicates the updated amount of time it will take to teach each concept.

14. The computer program product of claim 11, wherein the information related to the unexpected event is received from sources selected from the group consisting of social media and weather channels.

15. The computer program product of claim 11, wherein the program instructions are further executable to cause the computing device to calculate an amount of time it will take to teach concepts related to the topic after the unexpected event.

16. The computer program product of claim 11, wherein the amount of time that it will take to teach the topic is selected from the group consisting of a standard number of lectures and a standard number of hours.

17. The computer program product of claim 11, wherein the automatically reorganizing the schedule across the multiple lectures includes generating a schedule such that teaching a respective concept does not span across more than one lecture.

18. The computer program product of claim 11, wherein the reorganized schedule is reported to educators.

19. The computer program product of claim 11, wherein the program instructions are further executable to cause the computing device to compute the updated amount of time that it will take to teach the topic based on information related to a duration it took to teach courses to date.

20. The computer program product of claim 11, wherein the program instructions are further executable to cause the computing device to generate concepts related to the topic that are excludable from the schedule.
